(19) United States
(12) Patent Application Publication
(10) Pub. No.: US 2004/0010380 A1
(43) Pub. Date: Jan. 15, 2004

(54) Method of detecting a polishing end point in a chemical mechanical polishing process

(76) Inventor: Hyung Jun Kim, Cheongjoo-Shi (KR)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/616,198

(22) Filed: Jul. 9, 2003

(30) Foreign Application Priority Data
Jul. 11, 2002 (KR) 2002-40465

(51) Int. Cl. G06F 19/00

(52) U.S. Cl. 702/23

(57) ABSTRACT

Disclosed is a method of detecting a polishing end point in a chemical mechanical polishing process. Variation in the concentration of a material within an initial polishing layer or a material within a polishing stop layer, which are contained in polishing waste water drained during a polishing process, are monitored. A polishing process condition is adequately controlled or the polishing process is finished, depending on variation data value in the monitored concentration. It is thus possible to exactly detect the polishing end point regardless of the type of the materials in the initial polishing layer and the polishing stop layer. Therefore, reproducibility of the polishing process can be improved.

### BACKGROUND OF THE INVENTION

1. Field of the Invention

The present invention relates to a method of detecting a polishing end point in a chemical mechanical polishing process, and more particularly, to a method of detecting a polishing end point in a chemical mechanical polishing process by which a polishing end point can be easily detected using variation in the concentration of a polishing waster water, in the end point detection technology wherein the final polishing state is automatically recognized to control the process in the chemical mechanical polishing process.

2. Background of the Related Art

In general, a chemical mechanical polishing process of processes applied to the process of manufacturing semiconductor devices, an end point detection (EPD) technology in which the final polishing state is automatically recognized to control the process utilizes widely from a method of using variation in the friction force between the pad and the wafer and variation in the temperature of the pad to a method of using an light source.

Recently, a light source EPD technology has been widely used by which heterogeneous thin films are polished regardless of the selective ration of slurry while using the EPD source as the light source unlike from the method of using the friction force. However, the light source EPD technology requires equipments relating to the window pad and the platen through which the light source can pass since the light source must be scanned on the entire wafer during polishing. Accordingly, this technology has disadvantages that the above factor must be considered when the equipment is manufactured and it is difficult to address any problem using this technology. Also, this technology has disadvantages that the window pad used as expendables must be designed so that light can penetrate a material of the window portion while being same to polishing sheet, the boundary portion with polishing sheet be elaborate so that liquid such as slurry, etc. could not penetrate it, scratch should not occur on the wafer, and the like. Due to this, this technology needs high manufacture cost. Further, this technology has a problem that process reproducibility is degraded due to poor light source, modulated signal, etc. since liquid penetrates the window portion when this technology is used for a long time. One of the problems in the light source EPD method that has been widely used, is that process reproducibility is significantly varied depending on the type of a film to be polished.

Generally, process reproducibility is high since transfer of a line metal and a barrier metal is easily detected by the light source EPD technology in metal chemical mechanical polishing. However, a detection ratio in transfer of the barrier metal and the interlayer insulating film is significantly changed depending on a film to be polished. Due to this, there is a trend that the process is controlled using polishing time. For example, in the process of forming a copper line by means of a damascene scheme, transfer of the copper (Cu) layer and a tantalum (Ta) layer could be controlled by the EPD technology. However, transfer of the tantalum layer and an insulating film is controlled using the polishing process since it is difficult to detect by means of the EPD technology.

### SUMMARY OF THE INVENTION

Accordingly, the present invention is contrived to substantially obviate one or more problems due to limitations and disadvantages of the related art, and an object of the present invention is to provide a method of detecting a polishing end point in a chemical mechanical polishing process capable of not only easily detecting the polishing end point but also improving reproducibility of a polishing process, by using variation in the concentration of a polishing waste water without using a light source EPD method.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In a preferred embodiment, a method of detecting a polishing end point in a chemical mechanical polishing process is characterized in that it comprises the steps of using a sensor detecting variation in the concentration of a material within an initial polishing layer or a material within a polishing stop layer, which are contained in polishing waste water drained during a polishing process, using an EDP system to database information detected by the sensor, feeding back the result to a polisher in real time, wherein if a result that there is no change in the concentration of the material within the initial polishing layer is obtained, the polishing process continuously proceeds with an initial polishing process condition, if a result that variation in the concentration of the material within the initial polishing layer is reduced and variation in the concentration of the material within the polishing stop layer is increased, is obtained, performing the polishing process by lowering a polishing pressure, and if a result that variation in the concentration of the material within the initial polishing layer is not reduced but kept constant and variation in the concentration of the material within the polishing stop layer is not increased but kept constant, is obtained, using the EPD system to send a polishing process stop signal to the polisher, thus stopping the polishing process.

In another aspect of the present invention, it is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view of a CMP (chemical mechanical polishing) equipment for explaining a method of detecting a polishing end point in a chemical mechanical polishing process according to present invention,

FIG. 2A-FIG. 2D are cross-sectional views of devices for explaining a method of detecting a polishing end point in a chemical mechanical polishing process according to present invention, and

FIG. 3 is a graph illustrating variation in the concentration of a material within an initial polishing layer and a material within a polishing stop layer, which are contained in polishing waster water during the chemical mechanical polishing process.

### DETAILED DESCRIPTION OF THE PREFERRED EMBODIMENT

Reference will now be made in detail to the preferred embodiments of the present invention, examples of which are illustrated in the accompanying drawings.

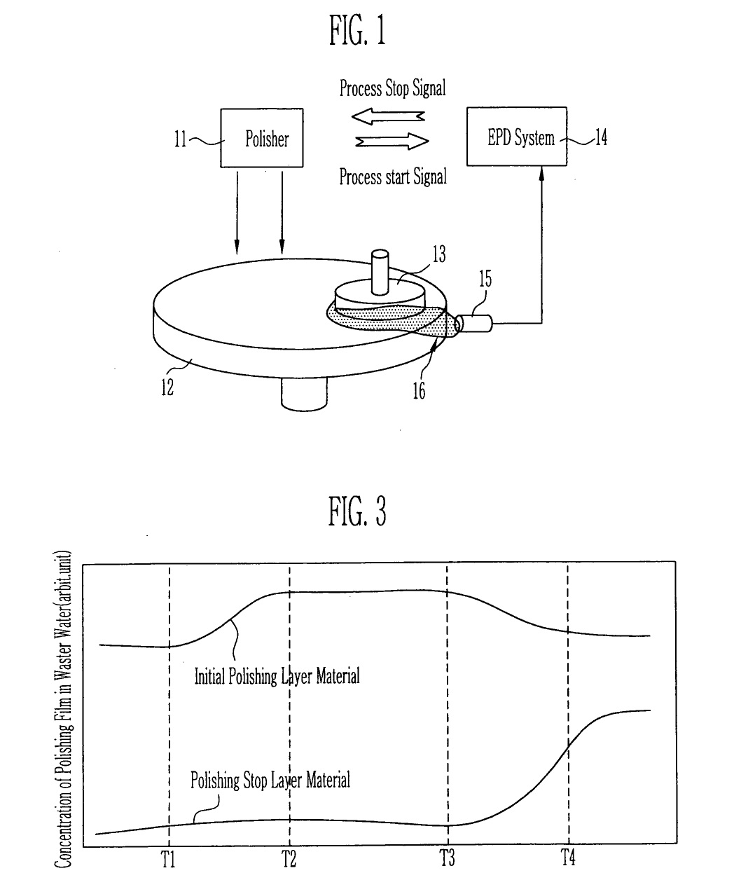

FIG. 1 is a schematic view of a CMP (chemical mechanical polishing) equipment for explaining a method of detecting a polishing end point in a chemical mechanical polishing process according to present invention.

The CMP equipment used for the method of detecting the polishing end point in a chemical mechanical polishing process according to the present invention comprises a polisher 11, a polishing table 12, a carrier 13 and an EPD (end point detection) system 14 as conventional constitution elements. The CMP equipment further comprises a sensor 15 connected to the EDP system 14, which is located at a point where polishing wastewater 16 around the polishing table 12 is drained.

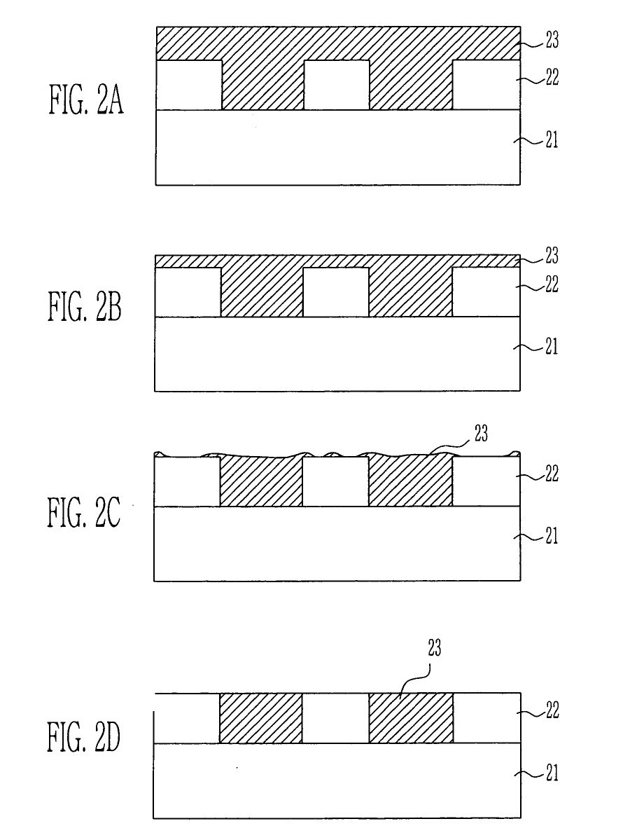

FIG. 2A-FIG. 2D are cross-sectional views of devices for explaining a method of detecting a polishing end point in a chemical mechanical polishing process according to present invention. FIG. 3 is a graph illustrating variation in the concentration of a material within an initial polishing layer and a material within a polishing stop layer, which are contained in polishing waster water during the chemical mechanical polishing process.

Referring to FIG. 1, FIG. 2A-FIG. 2D and FIG. 3, the method of detecting the polishing end point in a chemical mechanical polishing process according to the present invention will be below described in detail.

A polishing stop layer 22 is formed on a wafer 21. An initial polishing layer 23 is then formed on the polishing stop layer 22. Next, the wafer 21 is loaded onto the polishing table 12. At this time, as shown in the graph illustrating variation in the concentration until a first point (T1) representing a before-polishing state, variation in the concentration is not detected in the sensor 15 since it is before polishing. Therefore, there is no change in the concentration of a material within the initial polishing layer 23 and a material within the polishing stop layer 22 (FIG. 2A).

If a polishing process starts, the polishing wastewater 16 is drained. At the same time, change in the concentration of the material within the initial polishing layer 23 or the material within the polishing stop layer 22 contained in the drained polishing wastewater 16 is detected in the sensor 15. Information detected by the sensor 15 is then databased in the EPD system 14. The result is then fed back to the polisher 11 in real time.

As shown in FIG. 2B, after the polishing process started, the initial polishing layer 23 is polished. As shown in the graph illustrating variation in the concentration from the first point (T1) to a second point (T2), at an early polishing process, the concentration of the material within the initial polishing layer 23 is gradually increased. Also, there is no change in the concentration. of the material within the polishing stop layer 22. This is because the material of the polishing stop layer is not contained in the polishing wastewater since the material layer of the polishing stop layer is not polished.

As shown in the graph illustrating variation in the concentration from the second point (T2) to a third point (T3), the concentration that was increased at the middle of the polishing process is kept constant. Also, there is no change in the concentration of the material within the polishing stop layer 22 like the early polishing process. Variation in the concentration from the first point (T1) to the third point (T3) is detected in the sensor 15. Information detected by the sensor 15 is then databased in the EPD system 14. Next, the result is fed back to the polisher 11 in real time. Accordingly, the polishing process proceeds according to the initial polishing condition.

As shown in the graph illustrating variation in the concentration from the third point (T3) to a fourth point (T4), at a later polishing process, the concentration of the material within the initial polishing layer 23 is reduced but the concentration of the material within the polishing stop layer 22 is increased. If variation in this concentration is fed back to the polisher 11 by the EDP system 14, a finishing polishing process proceeds like a CLC (closed loop control) system automatically lowers the polishing pressure according to the above result (FIG. 2C).

As shown in the graph illustrating variation in the concentration after the fourth point (T4), the concentration in the material of the initial polishing layer 23 is gradually reduced as far as little and then constantly kept low. Also, the concentration of the material within the polishing stop layer 22 is constantly kept high. If the EPD system 14 obtains a result of this variation in the concentration, it determines that polishing of the initial polishing layer 23 is finished and sends a process stop signal to the polisher 11, so that the polishing process can stop (FIG. 2D).

In the embodiment of the present invention, the method of measuring the concentration may include a method of directly measuring the absolute value of the concentration or a method of measuring variation in the concentration. Further, the polishing table 12 could be manufactured with slant by a given angle so that the polishing wastewater 16 falls down unilaterally, i.e., at the sensor 15.

Meanwhile, in the present embodiment, the method of detecting the polishing end point in a chemical mechanical polishing process has been described using the sensor for detecting variation in the concentration of the material within the initial polishing layer and the material within the polishing stop layer, which are contained in the polishing waste water. However, it should be understood that several other embodiments might be implemented using this principle. In other words, the polishing state of the wafer could. be controlled by measuring the concentration in a specific element from the polishing waste water, by measuring physical and chemical variation value representing the polishing waste water depending on variation in the polishing state, and by measuring the ionic conductivity, the suspension degree, the specific gravity, the coefficient of viscosity, etc. of a specific element from the polishing waste water.

As described above, the present invention has advantageous effects that it can monitor the process and improve process reproducibility, regardless of the selective ration of a slurry or the type of a material to be polished using variation in the concentration of the polishing waste water.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of detecting a polishing end point in a chemical mechanical polishing process, comprising the steps of:
using a sensor detecting variation in the concentration of a material within an initial polishing layer or a material within a polishing stop layer, which are contained in polishing wastewater drained during a polishing process;
using an EDP system to database information detected by the sensor;
feeding back the result to a polisher in real time, wherein if a result that there is no change in the concentration of the material within the initial polishing layer is obtained, the polishing process continuously proceeds with an initial polishing process condition;
if a result that variation in the concentration of the material within the initial polishing layer is reduced and variation in the concentration of the material within the polishing stop layer is increased, is obtained, performing the polishing process by lowering a polishing pressure; and
if a result that variation in the concentration of the material within the initial polishing layer is not reduced but kept constant and variation in the concentration of the material within the polishing stop layer is not increased but kept constant, is obtained, using the EPD system to send a polishing process stop signal to the polisher, thus stopping the polishing process.
